(19) United States
(12) Patent Application Publication
(10) Pub. No.: US 2005/0229801 A1
(43) Pub. Date: Oct. 20, 2005

(54) Transfer method and transfer sheet

(76) Inventors: Nobuo Sugino, Yokohama-shi (JP); Junko Sugino, Yokohama-shi (JP)

Correspondence Address: Antonelli Terry Stout & Kraus, 1300 North Seventeenth St, Suite 1800, Arlington, VA, 22209, US

(21) Appl. No.: 10/507,317

(22) PCT Filed: Oct. 4, 2002
(86) PCT No.: PCT/JP02/10359

§ 371 Date: Sep. 10, 2004

(30) Foreign Application Priority Data
Mar. 12, 2002 (JP) 2002-66569
Apr. 4, 2002 (JP) 2002-102529
Jun. 18, 2002 (JP) 2002-17616

(51) Int. Cl. B41N 1/00

(52) U.S. Cl. 101/454

(57) ABSTRACT

A transfer method and a transfer sheet for easily preparing a transfer sheet having a desirable transfer pattern, etc. copied or printed thereon by using a color copier, a color printer, etc. employing a resin toner, and easily performing the transfer onto any material. The transfer method comprises a copy or print sheet forming step affixing a sheet to a film such as a cellophane to be swelled so as to perform the copy or print employing the resin toner, a copying or printing step of using this copy or print sheet for preparing a first transfer sheet by copying or printing the pattern or the like for transfer by employing the resin toner onto the film surface, a copy surface swelling step of swelling the copy surface of the first transfer sheet, a transfer sheet preparing step of preparing a second transfer sheet by adhering the copy surface to an adhesive surface of an adhesive film, so that the image of the pattern or the like for transfer is transferred onto the adhesive surface, and a transferring step of affixing the prepared second transfer sheet to a transfer part, and applying the heat of an iron, etc. to transfer the image.

### TECHNICAL FIELD

The present invention is related to a transfer method and a transfer sheet by utilizing a color copy or a printing technique, such as a color copier or a color printer, while mainly using resin toners.

### BACKGROUND ART

As conventional transfer paper, such transfer paper has been used in which transfer patterns or the like have been printed on a sheet by employing sublimation paints.

Since the conventional transfer paper employs the sublimation paints, any user can not always form such transfer paper, and there is no way except that commercially available transfer paper is merely used. Thus, there is such a drawback that transfer patterns, and the like, which are desired by users, can be hardly obtained.

Also, there is another drawback: that is, since sublimation transfer paper is employed, transfer patterns can be transferred only to cloth texture or the like made of certain synthetic resin.

### DISCLOSURE OF THE INVENTION

The present invention has been made to solve the drawbacks of the prior art, and therefore, has an object to provide a transfer method and a transfer sheet, by which while an user simply employs a color copier, a color printer or the like, with employment of a resin toner, such a transfer sheet on which the user's desirable transfer pattern, or the like, has been copied or printed; and also, the desirable transfer pattern, or the like can be readily transferred to any sorts of materials.

The above-described object, other objects, and novel features of the present invention may be completely apparent by reading the below-mentioned explanations in conjunction with the accompanying drawings.

It should be understood that the accompanying drawings are merely employed so as to understand the present invention, but never restricts the technical scope of the present invention.

To achieve the above-described objects, the present invention constitutes a transfer method comprising: a copy or print sheet forming step in which a sheet is affixed to a film such as a cellophane or a cellophane substitutable material, which is to be swelled, so as to form a copy or print sheet, in order that a copying or printing operation can be carried out by employing a resin toner; a copying or printing step in which while the copy or print sheet is employed which has been formed in the copy or print sheet forming step, a transfer purpose pattern or the like is copied or printed on a surface of the film with employment of the resin toner so as to form a first transfer sheet; a copy surface swelling step for swelling a copy or print surface of the first transfer sheet after the copying or printing step; a transfer sheet preparing step in which before/after the copy surface swelling step, the copy or print surface of the first transfer sheet is adhered to either an adhesive surface of a transparent, or semi-transparent adhesive film or an adhesive surface of an adhesive sheet, and an image of the transfer purpose pattern or the like of the copy or print surface is transferred to the adhesive surface so as to form a second transfer sheet; and a transferring step in which the second transfer sheet prepared in the transfer sheet preparing step is affixed to a transfer portion so as to affix the image to the transfer portion, or heat of an iron or the like is applied to the second transfer sheet so as to transfer the image to the transfer portion.

Also, the present invention constitutes a transfer method comprising: a copy or print sheet forming step in which a release agent sheet is affixed to a sheet, or a release agent is coated or adhered on a surface of a sheet, to form a copy or print sheet, in order that a copying or printing operation can be carried out; a copying or printing step in which while the copy or print sheet is employed which has been formed in the copy or print sheet forming step, a transfer purpose pattern or the like is copied or printed on a surface of the release agent sheet, a surface coated by the release agent, or an adhesive surface, with employment of a resin toner so as to form a first transfer sheet; a transfer sheet preparing step in which after the copying or printing step, the copy or print surface of the first transfer sheet is adhered to either an adhesive surface of a transparent, or semi-transparent adhesive film or an adhesive surface of an adhesive sheet, and an image of the transfer purpose pattern or the like of the copy or print surface is transferred to the adhesive surface so as to prepare a second transfer sheet; and a transferring step in which the second transfer sheet prepared in the transfer sheet preparing step is affixed to a transfer portion, and thereafter heat of an iron or the like is applied to the second transfer sheet so as to transfer the image to the transfer portion and the second transfer sheet is removed.

Further, the present invention constitutes a transfer method comprising: a copy or print sheet forming step in which a release agent sheet is affixed to a sheet, or a release agent is coated or adhered on a surface of a sheet, to form a copy or print sheet, in order that a copying or printing operation can be carried out; a copying or printing step in which while the copy or print sheet is employed which has been formed in the copy or print sheet forming step, a image of a transfer purpose pattern or the like is copied or printed on a surface of the release agent sheet, a surface coated by the release agent, or a surface adhered by the release agent, so as to prepare a transfer sheet; a transferring step in which the transfer sheet is affixed to a transfer portion so as to affix the image to the transfer portion, via an affixing agent, an adhesive agent, or a hot melt resin, which has been coated or adhered onto a copy or print surface of the transfer sheet, or the transfer portion, the affixing agent, the adhesive agent or the hot melt resin being transparent, semi-transparent or white-colored and the transfer sheet is removed; and a designing step in which the image of the transfer sheet is additionally transfer to the transfer portion where the image has been transferred in the transferring step by means of image superimposing, whereby another design of the transferred images is obtained.

Further, the present invention constitute a transfer method comprising: a copying or printing step in which while a copy or print sheet is employed in which a film such as a cellophane to be swelled on a cellophane substitutable material to be swelled has been affixed to a sheet, a transfer purpose pattern or the like, is copied or printed on a surface of the film with employment of a resin toner; a copy surface swelling step for swelling a copy or print surface of the first transfer sheet after the copying or printing step; a transfer sheet preparing step in which before/after the copy surface swelling step, the copy or print surface of the first transfer sheet is adhered to either an adhesive surface of a transparent or semi-transparent adhesive film, or an adhesive surface of an adhesive sheet, and an image of the transfer purpose pattern or the like of the copy or print surface is transferred to the adhesive surface so as to prepare a second transfer sheet; and a transferring step in which the second transfer sheet prepared in the transfer sheet preparing step is affixed to a transfer portion so as to affix the image to the transfer portion, or heat of an iron or the like is applied to the second transfer sheet so as to transfer the image to the transfer portion.

Furthermore, the present invention constitute a transfer method comprising: a copying or printing step in which while a release agent sheet is affixed to a sheet, or a release agent is coated or adhered on a surface of a sheet, to form a copy or print sheet, a transfer purpose pattern or the like is copied or printed on a surface of the release agent sheet, a surface coated by the release agent, or a surface adhered by the release agent so as to prepare a first transfer sheet; a transfer sheet preparing step in which after the copying or printing step, the copy or print surface of the first transfer sheet is adhered to either an adhesive surface of a transparent or semi-transparent adhesive film or an adhesive surface of an adhesive sheet, and an image of the transfer purpose pattern or the like of the copy or print surface is transferred to the adhesive surface so as to prepare a second transfer sheet; and a transferring step in which the second transfer sheet prepared in the transfer sheet preparing step is affixed to a transfer portion, and thereafter heat of an iron or the like is applied to the second transfer sheet so as to transfer the image to the transfer portion and the second transfer sheet is removed.

Moreover, the present invention constructs a transfer method comprising: a copying or printing step in which while a release agent sheet is affixed to a sheet, or a release agent is coated or adhered on a surface of a sheet, to form a copy or print sheet, an image of a transfer purpose pattern or the like is copied or printed on a surface of the release agent sheet, a surface coated by the release agent, or a surface adhered by the release agent so as to form a transfer sheet; a transferring step in which the transfer sheet is affixed to a transfer portion so as to affix the image to the transfer portion, via an affixing agent, an adhesive agent, or a hot melt resin, which has been coated or adhered on a copy or print surface of the transfer sheet, or the transfer portion, the affixing agent, the adhesive agent or the hot melt resin being transparent, semi-transparent or white-colored, and the transfer sheet is removed; and a designing step in which the image of the transfer sheet is additionally transfer to the transfer portion where the image has been transferred in the transferring step by means of image superimposing, whereby another design of the transferred images is obtained.

In addition, the present invention constructs a method of preparing a second transfer sheet wherein: a film surface of a first transfer sheet is swelled, in which an image of a transfer purpose pattern or the like has been formed on a film surface of a copy or print sheet, the copy or print sheet being formed by affixing a sheet to a film such as a cellophane or a cellophane substitutable material to be swelled in order that a copying or printing operation can be carried out by employing a resin toner; the swelled film surface of the first transfer sheet is affixed to either an adhesive surface of a transparent or semi-transparent adhesive film or an adhesive surface of an adhesive sheet; or the film surface of the first transfer sheet is affixed to either the adhesive surface of the transparent or semi-transparent adhesive film or the adhesive sheet and then is swelled; and the first transfer sheet is removed so as to form the second transfer sheet having the transferred pattern on the adhesive surface.

### BRIEF DESCRIPTION OF THE DRAWINGS

FIG. 1 is a view showing steps of a first embodiment of the present invention.

FIG. 2 is an explanatory view showing a copy or print sheet forming step.

FIG. 3 is an explanatory view showing a copying or printing step of the first embodiment of the present invention.

FIG. 4 is an explanatory view showing a copy surface swelling step of the first embodiment of the present invention.

FIG. 5 is an explanatory view showing a transfer sheet preparing step of the first embodiment of the present invention.

FIG. 6 is an explanatory view showing a transferring step of the first embodiment of the present invention.

FIG. 7 is an explanatory view showing another transferring step of the first embodiment of the present invention.

FIG. 8 is an explanatory view showing a further transferring step of the first embodiment of the present invention.

FIG. 9 is a view showing steps of a second embodiment of the present invention.

FIG. 10 is an explanatory view showing a copy or print sheet forming step.

FIG. 11 is an explanatory view showing a transfer sheet preparing step of the second embodiment of the present invention.

FIG. 12 is a view showing steps of a third embodiment of the present invention.

FIG. 13 is an explanatory view showing a copy or print sheet forming step.

FIG. 14 is an explanatory view showing a copy surface swelling step of the third embodiment of the present invention.

FIG. 15 is a view showing steps of a fourth embodiment of the present invention.

FIG. 16 is an explanatory view showing a copy or print sheet forming step.

FIG. 17 is an explanatory view showing a transfer sheet preparing step of the fourth embodiment of the present invention.

FIG. 18 is a view showing steps of a fifth embodiment of the present invention.

FIG. 19 is an explanatory view showing a copy or print sheet forming step.

FIG. 20 is an explanatory view showing a transferring step of the fifth embodiment of the present invention.

### BEST MODE FOR CARRYING OUT THE INVENTION

Referring now to drawings, preferred embodiments of the present invention will be described in detail.

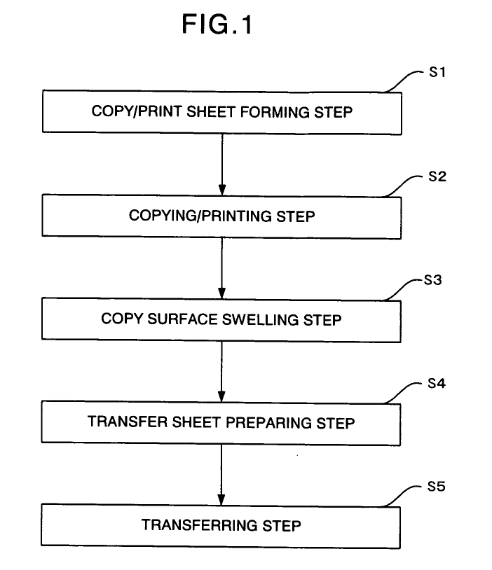

In a first embodiment of the present invention shown in FIG. 1 to FIG. 8, as represented in FIG. 1, a transfer method comprises a copy or print sheet forming step (step S1); a copying or printing step (step S2); a copy surface swelling step (step S3); a transfer sheet preparing step (step S4); and a transferring step (step S5).

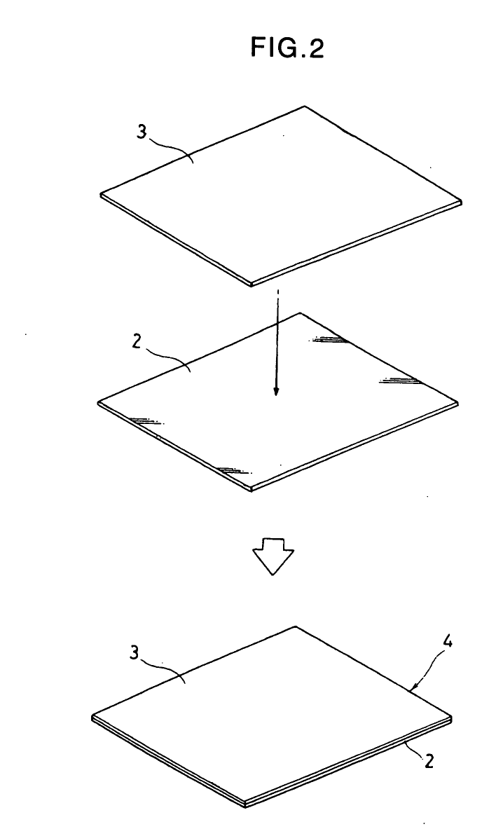

As shown in FIG. 2, the copy or print sheet forming step of the step S1 corresponds to such a step that a sheet such as handmade Japanese paper or copy paper is affixed to a film 2 such as a cellophane or a cellophane substitutable material, which is to be swelled, so as to form a copy or print sheet 4, in order that a copying or printing operation using a resin toner can be carried out. This copy or print sheet forming step is carried out manually or using a machine.

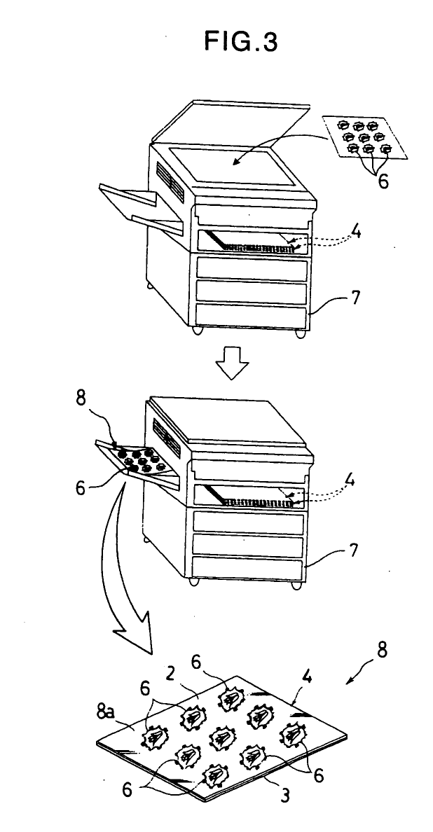

As shown in FIG. 3, the copying or printing step of the step S2 corresponds to such a step that while using the copy or print sheet 4 formed in the above-described copy or print sheet forming step of the step S1, a transfer purpose pattern 6 or the like is copied or printed on a surface of the film 2 by way of a color copier 7 or a color printer 7, which employs a resin toner, so as to form a first transfer sheet 8. This copying or printing step is executed in a similar manner to the conventional copying or printing method for forming the image on the sheet by the resin toner.

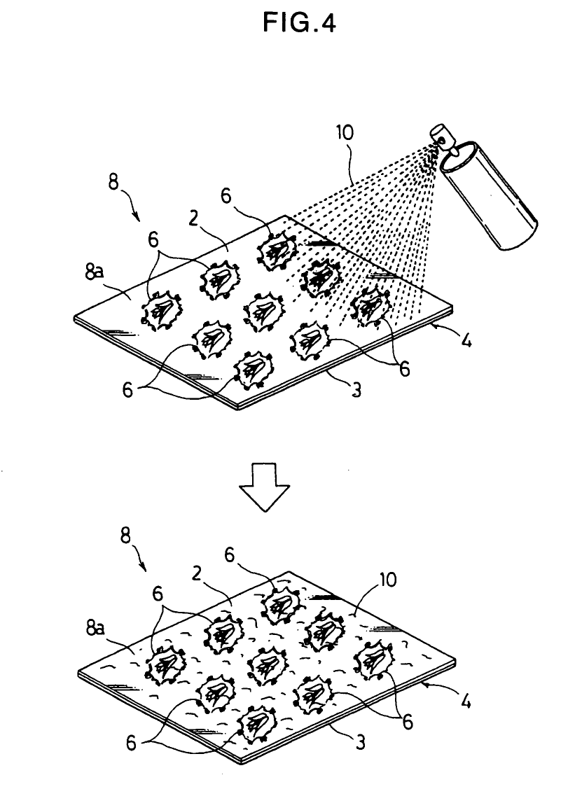

As shown in FIG. 4, the copy surface swelling step of the step S3 corresponds to such a step that a copy surface 8a of the first transfer sheet 8 is swelled after the above-described copying or printing step of the step S2. This copy surface swelling step is carried out in such a manner that water 10 is applied to the copy surface 8a by a spray or the like, the film 2 of the first transfer sheet 8 is swelled to become soft, and thus, a toner image of the transfer purpose pattern 6, etc. which is adhered to this swelled film 2 can be easily released from the film 2.

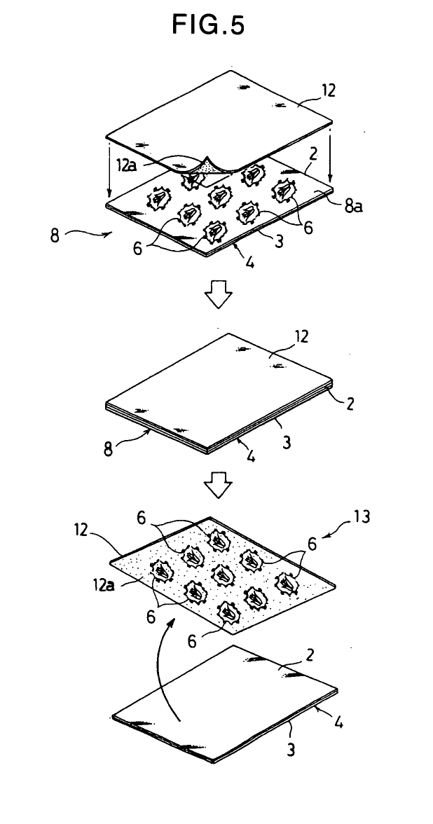

The transfer sheet preparing step of the step S4 corresponds to such a step that before/after the above-described copy surface swelling step of the step S3, especially after the above-described copy surface swelling step shown in FIG. 4 in the first embodiment of the present invention, as shown in FIG. 5, the copy surface 8a is adhered onto an adhesive surface 12a of either an adhesive film or an adhesive sheet 12, and the image of the transfer purpose pattern 6, etc. of the copy surface 8a is transferred to the adhesive surface 12a so as to prepare a second transfer sheet 13. In this transfer sheet preparing step, since the film 2 of the copy surface 8a has been swelled to become soft by the process of the above-described copy surface swelling step, and the image of the transfer purpose pattern 6, etc. could be easily released from the film 2, whereby the image of the transfer purpose pattern 6, etc. on the copy or print sheet 4 can be easily transferred to the adhesive surface 12a of either the adhesive film or the adhesive sheet 12 by simply pressing the image against the adhesive surface 12a.

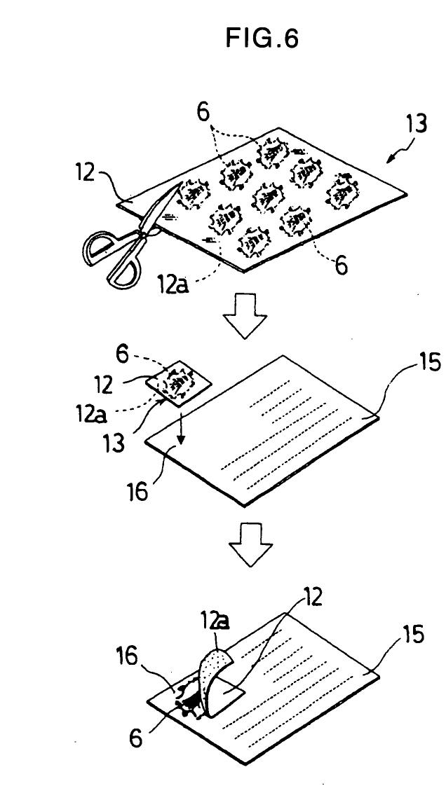

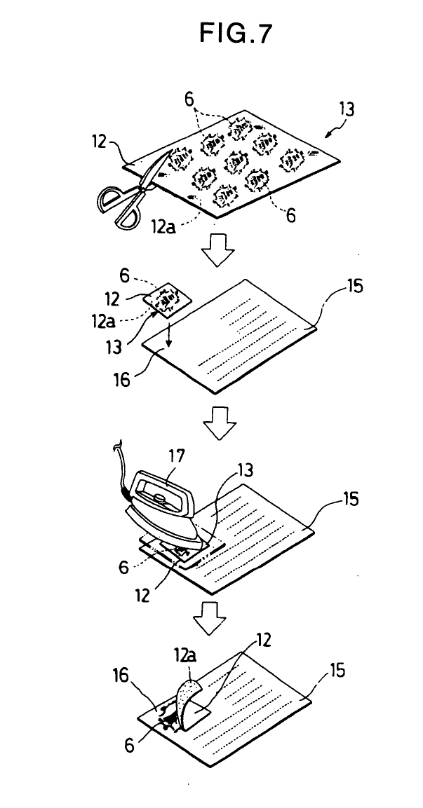

The transferring step of the step S5 corresponds to such a step that the second transfer sheet 13 which has been prepared in the above-described transfer sheet preparing step of the step S4 is transferred to a transfer portion 16 of a transfer-required material 15. In this transferring step, as represented in FIG. 6, the second transfer sheet 13 is arbitrarily cut and the arbitrarily-cut second transfer sheet 13 is used to transfer the image of the transfer purpose pattern 6 by affixing the adhesive surface 12a to the transfer portion 16; or alternatively, and as shown in FIG. 7, after the adhesive surface 12a of the arbitrarily-cut second transfer sheet 13 has been affixed to the transfer portion 16, heat is applied by an iron 17, etc. so as to transfer the image of the transfer purpose pattern 6, etc. from the second transfer sheet 13 to the transfer portion 16, and thereafter, the second transfer sheet 13 is removed. It should also be noted that in order to apply the heat for transferring the image, various sorts of press appliances containing an iron, and other known heating/pressing means may be alternatively used.

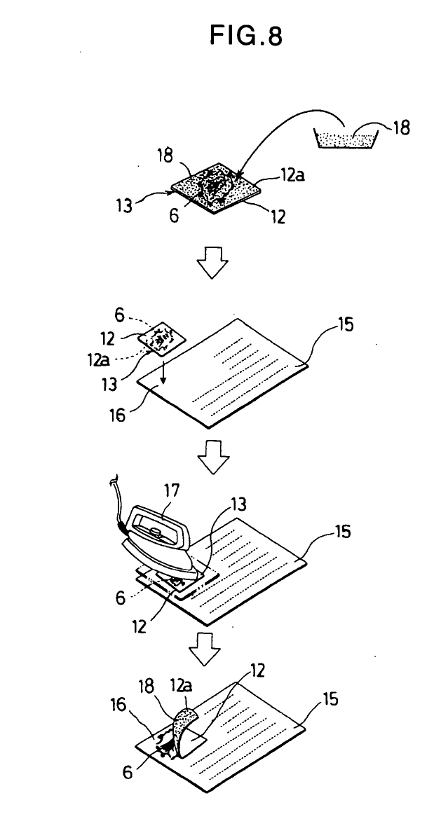

In this case, it should also be noted that a portion of adhesive components of the adhesive surface 12a maybe transferred to the transfer portion 16 together with the image of the transfer purpose pattern 6, etc., and therefore, a finished surface may be adhesive. In order to prevent or eliminate an occurrence of such an adhesive effect, as shown in FIG. 8, another transfer work may be alternatively carried out in such a manner that after an adhesive function has been eliminated by dusting, spraying, or coating powder 18 or other adhesive erasing agents to the adhesive surface 12a of the second transfer sheet 13, heat is applied by way of the iron 17, or the like. Also, after the image of the transfer purpose pattern 6, etc. has been transferred from the second transfer sheet 13 to the transfer portion 16 and then this second transfer sheet 13 has been removed, either the powder or other adhesive erasing agents may be put thereto by dusting, spraying, or coating.

In accordance with the transfer method of the first embodiment of the present invention, since the film 2 of the copy surface 8a is swelled, the very fine image portion of the transfer purpose pattern 6, etc. can be firmly transferred to either the adhesive surface of the adhesive film or the adhesive surface 12a of the adhesive sheet 12. As a consequence, the transfer sheets having the high qualities can be formed. Furthermore, the transfer purpose pattern 6, etc. which could faithfully represent any colors up to light colors and delicate colors can be firmly transferred to the transfer portion 16, so that clear pattern transferring operation can be carried out.

Also, since the transfer purpose pattern 6, etc., which is transferred to the transfer portion, corresponds to the image made of the resin toner, even when the transfer-desirable material 15 is selected from any sorts of materials (paper, cloth, leather, timber, stone, glass, etc.), the transfer purpose pattern 6, etc. can be easily transferred, and also, can be simply transferred not only to a plain surface, but also to a curved plane, and a three-dimensional article.

In addition, since the transfer operation is essentially carried out only by the transfer purpose pattern 6, etc. of the resin toner, even when a superimposing transfer operation is carried out, the transfer method of the first embodiment can firmly avoid such a drawback of a conventional superimposing transfer operation in that a pattern, etc., having been transferred, positioned at a lower portion disappears. As a consequence, since the superimposing transfer operation can be carried out, while a plurality of sheets of the second transfer sheets 13 whether the same sort or the different sorts are employed, the images of the transfer purpose pattern 6, etc. are sequentially superimposed onto the transfer portion, so that another transfer design using user's ingenuity may be obtained.

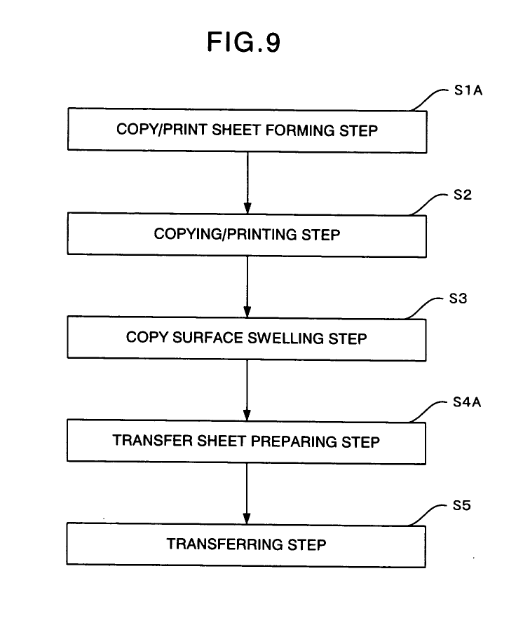

Next, a description is made of different embodiments of the present invention shown in FIG. 9 to FIG. 20. It should also be understood that the same reference numerals shown in the structural components of the above-described first embodiment of the present invention will be employed as those for denoting the same structural components of the different embodiments while these different embodiments of the present invention are described, and therefore, descriptions thereof are omitted.

In the second embodiment of the present invention shown in FIG. 9 to FIG. 11, as represented in FIG. 9, a transfer method comprises a copy or print sheet forming step (step S1A); a copying or printing step (step S2); a copy surface swelling step (step S3); a transfer sheet preparing step (step S4A); and a transferring step (step S5).

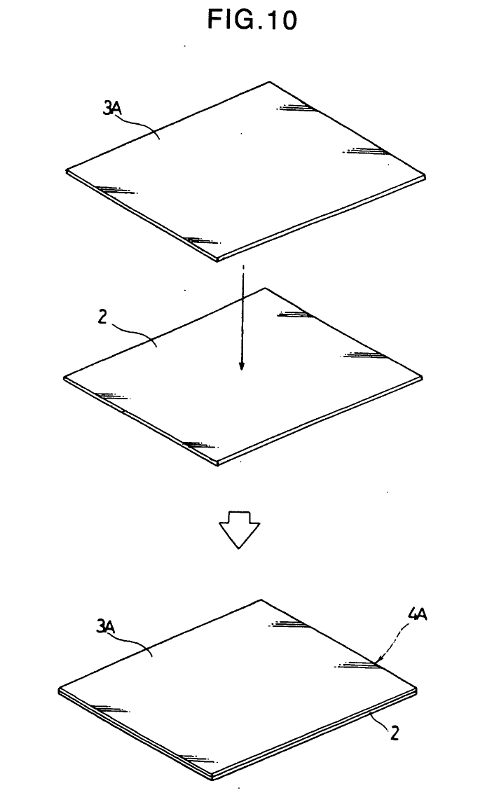

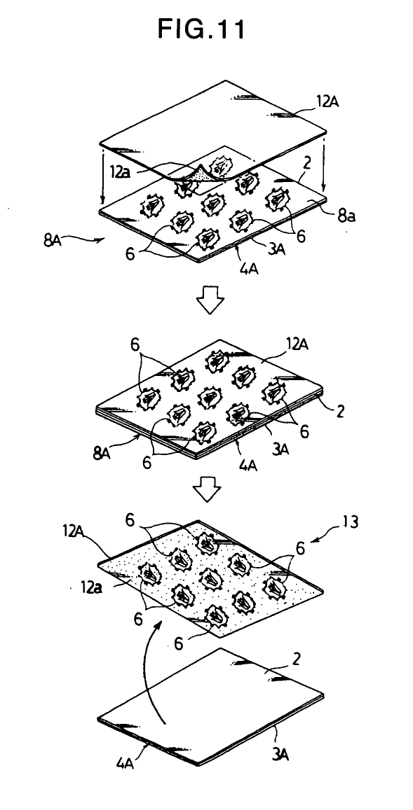

A major different point with respect to the above-described first embodiment of the present invention is given as follows: That is, in the copy or print sheet forming step of the step S1A, as shown in FIG. 10, a copy or print sheet 4A is formed in which a sheet 3A, being made of a transparent, or semi-transparent resin film, or tracing paper, is affixed to a film 2. Furthermore, in the transfer sheet preparing step of the step S4A, as shown in FIG. 11, while either a transparent, or semi-transparent adhesive film or an adhesive sheet 12A is employed, a copy surface 8a of a first transfer sheet 8A is adhered to an adhesive surface 12a of the transparent, or semi-transparent adhesive film, or of the adhesive sheet 12A, and then, an image of a transfer purpose pattern 6, etc., of the copy surface 8a is transferred to the adhesive surface 12a so as to prepare a second transfer sheet 13.

Since either such a transparent, or semi-transparent film or such an adhesive sheet 12A is employed, the second transfer sheet 13 can be prepared in which the image of the transfer purpose pattern 6, etc., on the first transfer sheet 8A has been firmly transferred to the user's favorite position of the adhesive film, or the adhesive sheet 12A. Moreover, the image of the transfer purpose pattern 6, etc. on the second transfer sheet 13 can be transferred in such a manner that the image can be firmly positioned to the user's favorite transfer portion. As a consequence, while a plurality of such second transfer sheets 13 wherein the patterns whether the same sort or the different sorts have been transferred to the adhesive surfaces 12a are prepared, the transfer purpose patterns 6, etc. can be readily transferred to the transfer portion by sequential superimpose. Also, while confirming by eyes, another transfer design using user's ingenuity can be simply obtained.

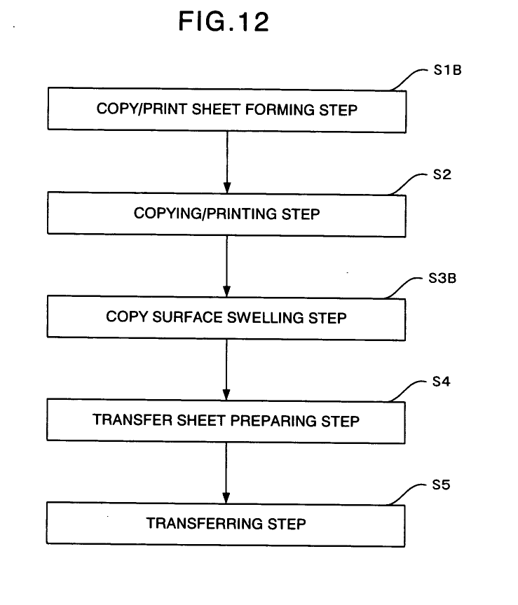

In a third embodiment of the present invention shown in FIG. 12 to FIG. 14, as represented in FIG. 12, a transfer method comprises a copy or print sheet forming step (step S1B); a copying or printing step (step S2); a copy surface swelling step (step S3B); a transfer sheet preparing step (step S4); and a transferring step (step S5).

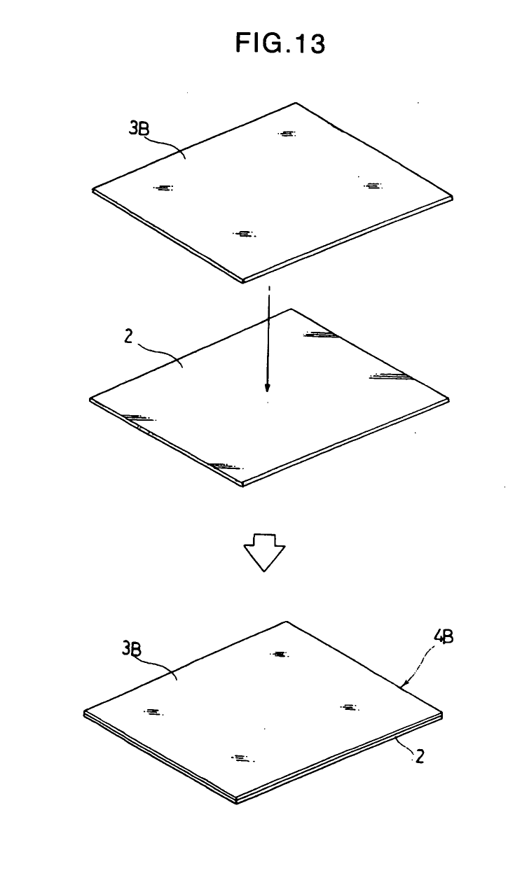

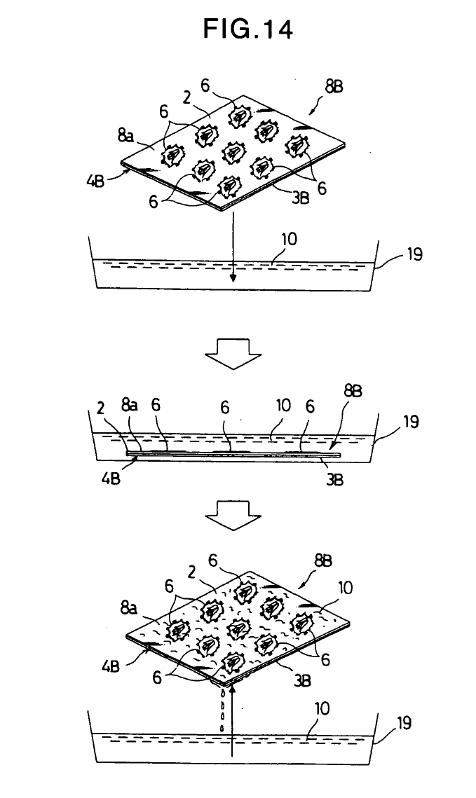

A major different point with respect to the above-described first embodiment is given as follows: That is to say, in the copy or print sheet forming step of the step S1B, as shown in FIG. 13, a copy or print sheet 4B is formed in such a manner that a sheet 3B made of a resign film is affixed to a film 2 such as a cellophane or a cellophane substitutable material. Since the copy or print sheet 4B is employed, which has been formed in such a copy or print sheet forming step of the step S1B, as shown in FIG. 14, the copy surface swelling step of the step S3B may be alternatively carried out by way of such a work that an entire portion of the first transfer sheet 8B is dipped into the water 10 contained in a vessel 19.

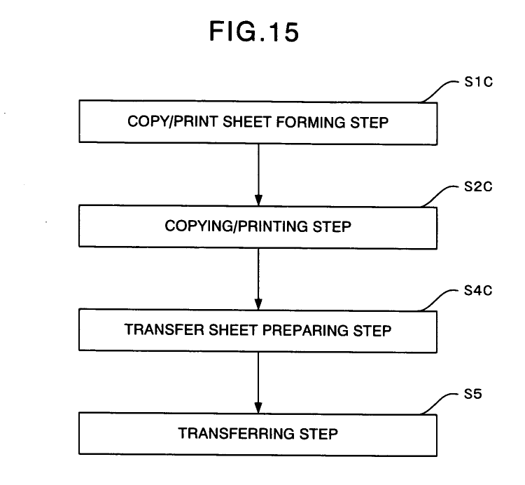

In a fourth embodiment of the present invention shown in FIG. 15 to FIG. 17, as represented in FIG. 15, a transfer method comprises a copy or print sheet forming step (step S1C); a copying or printing step (step S2C); a transfer sheet preparing step (step S4C); and a transferring step (step S5).

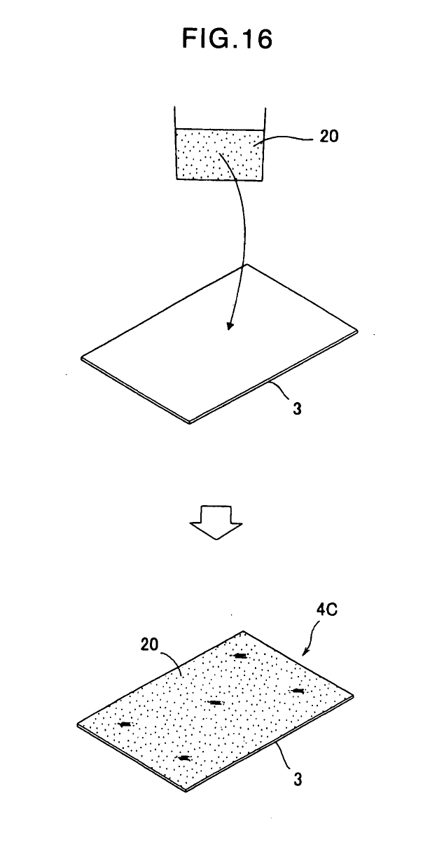

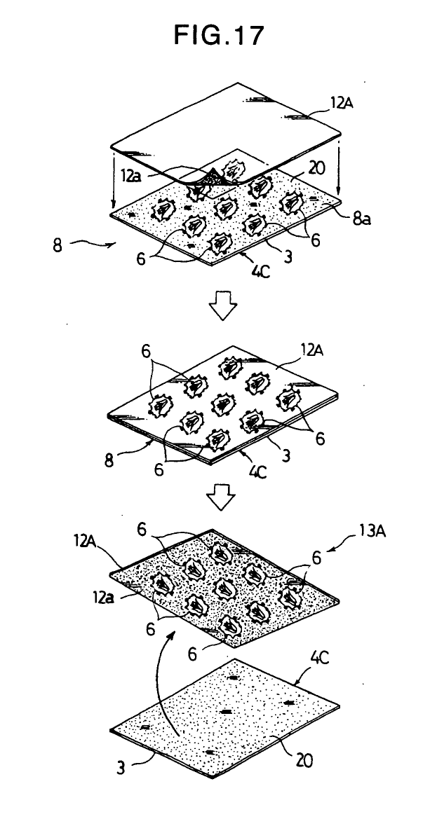

Major different points with respect to the above-described first to third embodiments are given as follows: That is to say, in the copy or print sheet forming step of the step S1C, as shown in FIG. 16, a copy or print sheet 4C is formed in such a manner that a release agent 20 has been coated onto, or adhered to this copy or print sheet 4C. Also, in the copying or printing step of the step S2C, while this copy or print sheet 4C is employed, a transfer purpose pattern 6, or the like, is copied by a color copier, or printed by a color printer 7, which employ a resin toner, on a surface which the release agent has been coated onto, or adhered to, so as to form a first transfer sheet 8. Further, in the transfer sheet preparing step of the step S4C, as represented in FIG. 17, after the copy or print step of the step S2C, a copy surface 8a of the first transfer sheet 8 is adhered to an adhesive surface 12a of a transparent, or semi-transparent adhesive film, or an adhesive sheet 12A, and then, an image of a transfer purpose pattern 6, etc. on the copy surface 8a is transferred to the adhesive surface 12a so as to prepare a second transfer sheet 13A. In the fourth embodiment of the present invention, since the copy or print sheet 4C in which the release agent 20 has been coated onto, or adhered to the sheet 3 is employed, the above-described copy surface swelling step in the first to third embodiments of the present invention is no longer required.

Even when the transfer method with employment of such steps is carried out, the below-mentioned operation effects similar to those of the above-described first embodiment can be achieved: That is to say, (a) the very fine image portion of the transfer purpose pattern 6, etc. can be firmly transferred to the adhesive surface 12a of the adhesive film 12A. As a consequence, the transfer sheets having the high qualities can be formed; (b) the transfer purpose pattern 6, etc. which could faithfully represent any colors up to light colors and delicate colors can be firmly transferred to the transfer portion 16, so that clear pattern transferring operation can be carried out; (c) even when the transfer-desirable material 15 is selected from any sorts of materials, the transfer purpose pattern 6, etc. can be easily transferred, and also, can be simply transferred not only to a plain surface, but also to a curved plane, and a three-dimensional article; (d) even when a superposing transfer operation is carried out, the transfer method can firmly avoid such a drawback of a conventional superimposing transfer operation in that a pattern, etc., having been transferred to a lower portion disappears, while the images of the transfer purpose pattern 6, etc. are sequentially superimposed onto the transfer portion, so that another transfer design using user's ingenuity may be obtained.

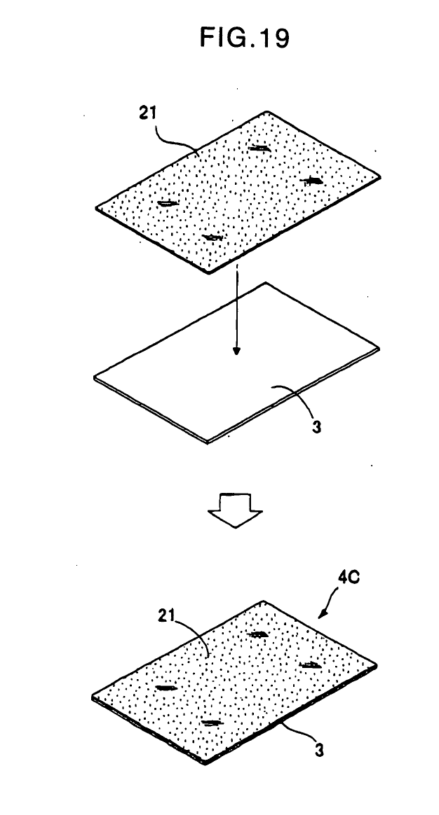

It should also be understood that as the copy or the print sheet 4C, the following materials may be alternatively employed, namely, either copy paper or the sheet 3 made of the resin film to which the release agent 20 has been previously coated or previously adhered to be fixed by a spray or the like; either copy paper or the sheet 3 made of the resin film to which a release agent sheet 21 formed in a thin sheet has been affixed (see FIG. 19); and a material to which the release agent 20 is coated by a spray or the like when the material is used.

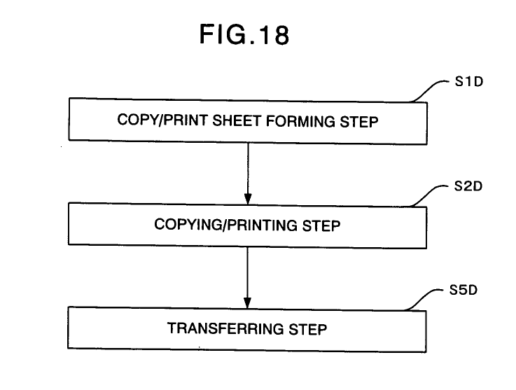

In a fifth embodiment of the present invention shown in FIG. 18 to FIG. 20, as represented in FIG. 18, a transfer method is constituted by a copy or print sheet forming step (step S1D); a copying or printing step (step S2D); and a transferring step (step S5D).

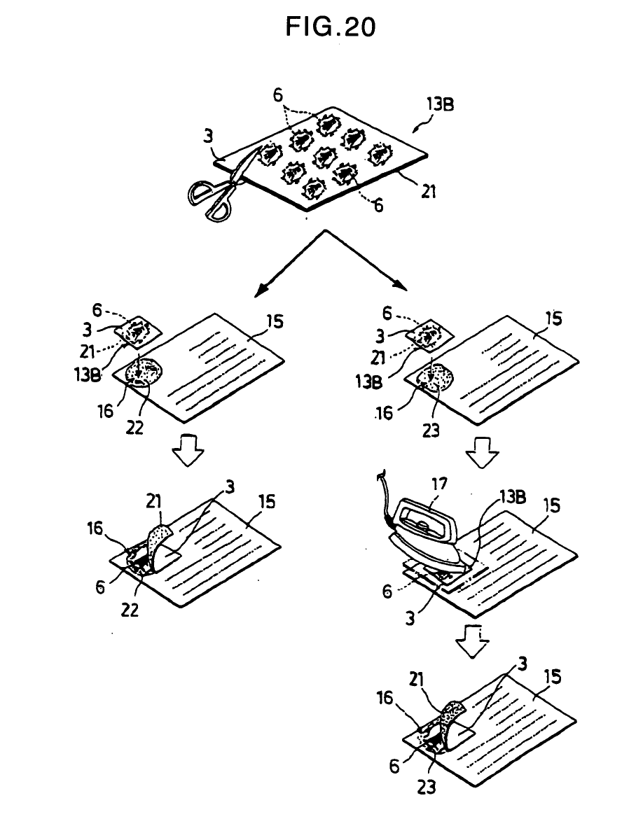

Major different points with respect to the above-described fourth embodiment are given as follows: That is to say, in the copy or print sheet forming step of the step S1D, as shown in FIG. 19, a copy or print sheet 4C is formed in such a manner that a release agent sheet 21 has been affixed to a sheet 3 in order to be capable of being copied or printed. Also, in the copying or printing step of the step S2D, while employing the copy or print sheet 4C which has been formed in this copy or print sheet forming step, a transfer purpose pattern 6, etc. is copied or printed on a surface of the release agent sheet 21 so as to form a transfer sheet 13B. Further, in the transferring step of the step S5D, an image is transferred via an affixing agent or an adhesive agent 22, or a hot melt resin 23 to a transfer portion 16 (in an example shown in FIG. 20), a copy surface, or a print surface of the transfer sheet 13B, or a transfer portion of the transfer sheet 13B by affixing the transfer sheet 13B to the transfer portion, or by applying heat of an iron to this transfer portion. The affixing agent, the adhesive agent, or the hot melt resin to be coated or adhered owns a white color, or represents either transparent or semi-transparent.

Even when the transfer method with employment of such steps is carried out, similar operation effects to those of the above-described fourth embodiment of the present invention may be achieved. Further, since the transfer sheet 13B can be formed by way of the copying or printing step of the step S2D without the step for forming the second transfer sheet from the first transfer sheet, although the inverted image of the transfer purpose pattern 6, etc. is transferred to the transfer portion 16, the steps can be further made simpler, and thus, the transfer sheet 13B can be easily manufactured. Also, since the image is transferred via the affixing agent or the adhesive agent 22, or the hot melt resin 23 to the transfer portion 16, the copy surface, or the print surface of the transfer sheet 13B, or the transfer portion of the transfer sheet 13B by affixing the transfer sheet 13B to the transfer portion, or by applying heat of the iron to this transfer portion, while the affixing agent, the adhesive agent or the hot melt resin to be coated or adhered owns the white color, or represents either transparent or semi-transparent, the image can be easily transferred to any curved portions, or any portions having concaves and convexes irrespective of the surface condition of the transfer-desirable material 15.

More specifically, since the white-colored affixing agent, the white-colored adhesive agent 22, or the white-colored hot melt resin 23 may provide a white-colored background on the surface of the transfer portion 16, even in such a case that the surface of the transfer portion 16 represents either black or dark color, there is such a merit that an image of a transfer purpose pattern or the like can be clearly transferred.

It should also be noted that the printing operation of the transfer purpose pattern 6, etc. to the print sheet 4C may be alternatively carried out by such a printing method as a relief printing method and a screen printing method, which has been generally and conventionally carried out.

In the above-described fifth embodiment of the present invention, the copy or print sheet forming step of the step S1D has been realized by such a step that the copy or print sheet 4C is formed in which the release agent sheet 21 shown in FIG. 19 has been affixed to the sheet 3 so as to be capable of being copied or printed. Alternatively, the step for forming the copy or print sheet 4C in which the release agent 20 has been coated, or adhered to the sheet 3, which has already been shown in FIG. 16, may be employed. In this alternative case, in the copying or printing step of the step S2D, the transfer purpose pattern 6, etc. may be copied or printed on the surface of the copy or print sheet 4C to which the release agent 20 has been coated or adhered so as to prepare the transfer sheet 13B.

The transfer method of the present invention may be alternatively changed, or modified in various manners. For instance, the first to the fifth embodiments of the present invention may be alternatively changed and/or modified as follows:
(1) In the above-described second embodiment, or fourth embodiment of the present invention, as either the adhesive film or the adhesive sheet 12A (refer to FIG. 11 and FIG. 17) which is used in the transfer sheet forming step of either the step S4A or the step S4C, either a semi-transparent porous film or a semi-transparent porous sheet such as thin handmade Japanese paper having an adhesive surface is employed so as to prepare the second transfer sheets 13 and 13A. In the transferring step of the step S5, the transfer purpose pattern 6 or the like, are transferred to the transfer portion, and also, is affixed via the adhesive surface to the transfer portion 16, while the second transfer sheets 13 and 13A are not removed. Either the semi-transparent porous adhesive film or the semi-transparent porous sheet such as the thin Japanese handmade paper having the adhesive surface may give a blurring effect to the image of the transfer purpose pattern 6 or the like located under the film/sheet, so that a design having a special taste may be obtained.
(2) Silicon resin is coated onto the surface of the semi-transparent porous film such as the thin Japanese handmade paper which has been affixed to the transfer portion in accordance with the above-described method (1). Since the silicon resin is filled into a large number of holes of either the porous film or the porous sheet, transparency of either the porous film or the porous sheet maybe increased, so that visibility of the image through the film may be improved.
(3) In the above-described fifth embodiment of the present invention, as the sheet 3 used in the copy or print sheet forming step of the step S1D, either a semi-transparent porous film or a semi-transparent porous sheet such as thin handmade Japanese paper is employed so as to prepare the second transfer sheet 13B. In the transferring step of the step S5D, the transfer purpose pattern 6, or the like, is transferred to the transfer portion, and also, is affixed via the adhesive surface to the transfer portion, while the second transfer sheet 13B is not removed. Also, in this case, operation effects similar to those of the above-described case (1) may be achieved.
(4) In the above-described first to fifth embodiments of the present invention, while the adhesive effect left on the transfer portion 16 is used in the transferring step, another thin Japanese handmade paper, a transparent or semi-transparent film, or a transparent or semi-transparent sheet is affixed to the transfer portion 16. The Japanese handmade paper, the transparent or semi-transparent film, or the transparent or semi-transparent sheet may protect the image of the transfer purpose pattern 6 or the like located under these materials from externally-applied force such as friction and scratch, and may avoid that the transferred image is damaged.
(5) In the above-described first to fifth embodiments of the present invention, while an affixing agent, an adhesive agent, or a hot melt resin has been previously coated, or adhered to either a portion or an entire surface of the transfer-desirable material 15, the transfer purpose pattern 6 or the like is transferred onto these materials in the transferring step, and furthermore, another thin Japanese handmade paper, a transparent or semi-transparent film, or a transparent or semi-transparent sheet is affixed to these materials. Also, in this case, similar operation effects to those of the above-described case (4) may be achieved.
(6) On the surface of the image of the transfer purpose pattern 6, etc., which has been transferred to the transfer portion 16 in accordance with the first to fifth embodiments of the present invention, a resin film made of acrylic resin, silicon, or polyester is formed in order to protect the image of the transfer purpose pattern 6 or the like located under these materials from externally-applied force such as friction and scratch, and so as to avoid that the transferred image is damaged.
(7) A coloration containing other pigments is added by using a writing brush, a felt pen or the like to the image of the transfer purpose pattern 6, etc., which has been transferred to the transfer portion 16 in accordance with the above-described first to fifth embodiments of the present invention. Alternatively, a portion of the image is released, or scratched by using either an adhesive tape or a cutter. As a result, the design may be changed in a creative manner.
(8) In the above-described first to fifth embodiments of the present invention, the copy or print sheet forming step may be alternatively executed in an external source such as a factory. Apparently, such a transfer method for executing the respective steps subsequent to the copying or printing step by employing a predetermined copy or print sheet which has been manufactured in such an external source may be covered by the technical scope of the present invention.

### INDUSTRIAL APPLICABILITY

As apparent from the above descriptions, in accordance with the present invention, the below-mentioned effects can be achieved:
(1) Since the transfer method comprises: a copy or print sheet forming step in which a sheet is affixed to a film such as a cellophane and a cellophane substitutable material, which is to be swelled, so as to form a copy or print sheet, in order that a copying or printing operation can be carried out by employing a resin toner; a copying or printing step in which while the copy or print sheet is employed which has been formed in the copy or print sheet forming step, a transfer purpose pattern or the like is copied or printed on a surface of the film with employment of the resin toner so as to form a first transfer sheet; a copy surface swelling step for swelling a copy or print surface of the first transfer sheet after the copying or printing step; a transfer sheet preparing step in which before/after the copy surface swelling step, the copy or print surface of the first transfer sheet is adhered to either an adhesive surface of a transparent, or semi-transparent adhesive film or an adhesive surface of an adhesive sheet, and an image of the transfer purpose pattern or the like of the copy or print surface is transferred to the adhesive surface so as to form a second transfer sheet; and a transferring step in which the second transfer sheet formed in the transfer sheet preparing step is affixed to a transfer portion so as to affix the image to the transfer portion, or heat of an iron or the like is applied to the second transfer sheet so as to transfer the image to the transfer portion, the copy surface of the first transfer sheet is swelled, and the transfer purpose pattern, etc., is transferred to the adhesive surface of either the adhesive film or the adhesive sheet, so that the transfer purpose pattern, etc., which has been copied or printed can be firmly transferred to either the adhesive film or the adhesive sheet so as to form the second transfer sheet.

As a consequence, the transfer sheet having the high quality can be formed, and the clear image transfer operation can be carried out.
(2) Since the copy or print using the resin toner is employed in accordance with the above-described method (1), everybody can easily form the pattern, etc., which is wanted to be transferred on the transfer sheet, and can enjoy transfer operation.
(3) Since the transfer purpose pattern, etc., which is transferred, corresponds to the resin toner image by the above-described method (1), even when any sorts of materials which will be transferred are employed, the pattern, etc., can be readily transferred. In addition, since only the transfer purpose pattern, etc., of the resin toner is transferred, even if the superimposing transfer operation is carried out, the present invention can firmly avoid such a drawback that the transfer purpose pattern, etc., of the lower portion disappears as explained in connection with the prior art.

As a consequence, a superposing transfer operation can be carried out, and also, such a design transfer operation can be carried out which is constructed by employing a plurality of sheets of transfer paper, although this design transfer operation could not be carried out in the prior art.
(4) As to transfer methods, or transfer sheets related to claims 2, 3, 4, 5, 6, and 8, similar effects to those of the above-described methods (1) to (3) may be achieved.

1. A transfer method comprising:
a copy or print sheet forming step in which a sheet is affixed to a film such as a cellophane or a cellophane substitutable material, which is to be swelled, so as to form a copy or print sheet, in order that a copying or printing operation can be carried out by employing a resin toner;
a copying or printing step in which while the copy or print sheet is employed which has been formed in said copy or print sheet forming step, a transfer purpose pattern or the like is copied or printed on a surface of the film with employment of the resin toner so as to form a first transfer sheet;
a copy surface swelling step for swelling a copy or print surface of said first transfer sheet after said copying or printing step;
a transfer sheet preparing step in which before/after said copy surface swelling step, the copy or print surface of said first transfer sheet is adhered to either an adhesive surface of a transparent, or semi-transparent adhesive film or an adhesive surface of an adhesive sheet, and an image of the transfer purpose pattern or the like of the copy or print surface is transferred to the adhesive surface so as to form a second transfer sheet; and
a transferring step in which said second transfer sheet formed in said transfer sheet preparing step is affixed to a transfer portion so as to affix the image to the transfer portion, or heat of an iron or the like is applied to said second transfer sheet so as to transfer the image to the transfer portion.

2. A transfer method comprising:
a copy or print sheet forming step in which a release agent sheet is affixed to a sheet, or a release agent is coated or adhered on a surface of a sheet, to form a copy or print sheet, in order that a copying or printing operation can be carried out;
a copying or printing step in which while the copy or print sheet is employed which has been formed in said copy or print sheet forming step, a transfer purpose pattern or the like is copied or printed on a surface of the release agent sheet, a surface coated by the release agent, or an adhesive surface, with employment of a resin toner so as to form a first transfer sheet;
a transfer sheet preparing step in which after said copying or printing step, the copy or print surface of said first transfer sheet is adhered to either an adhesive surface of a transparent or semi-transparent adhesive film or an adhesive surface of an adhesive sheet, and an image of the transfer purpose pattern or the like of the copy or print surface is transferred to the adhesive surface so as to prepare a second transfer sheet; and
a transferring step in which said second transfer sheet prepared in said transfer sheet preparing step is affixed to a transfer portion, and thereafter heat of an iron or the like is applied to said second transfer sheet so as to transfer the image to the transfer portion and said second transfer sheet is removed.

3. A transfer method comprising:
a copy or print sheet forming step in which a release agent sheet is affixed to a sheet, or a release agent is coated or adhered on a surface of a sheet, to form a copy or print sheet, in order that a copying or printing operation can be carried out;
a copying or printing step in which while the copy or print sheet is employed which has been formed in said copy or print sheet forming step, an image of a transfer purpose pattern or the like is copied or printed on a surface of the release agent sheet, a surface coated by the release agent, or a surface adhered by the release agent, so as to prepare a transfer sheet;
a transferring step in which the transfer sheet is affixed to a transfer portion so as to affix the image to the transfer portion, via an affixing agent, an adhesive agent, or a hot melt resin, which has been coated or adhered on a copy or print surface of the transfer sheet, or the transfer portion, the affixing agent, the adhesive agent or the hot melt resin being transparent, semi-transparent or white-colored and the transfer sheet is removed; and
a designing step in which the image of the transfer sheet is additionally transfer to the transfer portion where the image has been transferred in said transferring step by means of image superimposing, whereby another design of the transferred images is obtained.

4. A transfer method comprising:
a copying or printing step in which while a copy or print sheet is employed in which a film such as a cellophane to be swelled on a cellophane substitutable material to be swelled has been affixed to a sheet, a transfer purpose pattern or the like, is copied or printed on a surface of the film with employment of a resin toner;
a copy surface swelling step for swelling a copy or print surface of said first transfer sheet after said copying or printing step;
a transfer sheet preparing step in which before/after said copy surface swelling step, the copy or print surface of said first transfer sheet is adhered to either an adhesive surface of a transparent or semi-transparent adhesive film, or an adhesive surface of an adhesive sheet, and an image of the transfer purpose pattern or the like of the copy or print surface is transferred to the adhesive surface so as to prepare a second transfer sheet; and
a transferring step in which said second transfer sheet prepared in said transfer sheet preparing step is affixed to a transfer portion so as to affix the image to the transfer portion, or heat of an iron or the like is applied to said second transfer sheet so as to transfer the image to the transfer portion.

5. A transfer method comprising:
a copying or printing step in which while a release agent sheet is affixed to a sheet, or a release agent is coated or adhered on a surface of a sheet, to form a copy or print sheet, a transfer purpose pattern or the like is copied or printed on a surface of the release agent sheet, a surface coated by the release agent, or a surface adhered by the release agent so as to prepare a first transfer sheet;
a transfer sheet preparing step in which after said copying or printing step, the copy or print surface of said first transfer sheet is adhered to either an adhesive surface of a transparent or semi-transparent adhesive film or an adhesive surface of an adhesive sheet, and an image of the transfer purpose pattern or the like of the copy or print surface is transferred to the adhesive surface so as to prepare a second transfer sheet; and
a transferring step in which said second transfer sheet prepared in said transfer sheet preparing step is affixed to a transfer portion, and thereafter heat of an iron or the like is applied to said second transfer sheet so as to transfer the image to the transfer portion and said second transfer sheet is removed.

6. A transfer method comprising:
a copying or printing step in which while a release agent sheet is affixed to a sheet, or a release agent is coated or adhered on a surface of a sheet, to form a copy or print sheet, an image of a transfer purpose pattern or the like is copied or printed on a surface of the release agent sheet, a surface coated by the release agent, or a surface adhered by the release agent so as to form a transfer sheet;
a transferring step in which the transfer sheet is affixed to a transfer portion so as to affix the image to the transfer portion, via an affixing agent, an adhesive agent, or a hot melt resin, which has been coated or adhered on a copy or print surface of the transfer sheet, or the transfer portion, the affixing agent, the adhesive agent or the hot melt resin being transparent, semi-transparent or white-colored, and the transfer sheet is removed;
a designing step in which the image of the transfer sheet is additionally transfer to the transfer portion where the image has been transferred in said transferring step by means of image superimposing, whereby another design of the transferred images is obtained.

7. (canceled)

8. A method of preparing a second transfer sheet wherein:
a film surface of a first transfer sheet is swelled, in which an image of a transfer purpose pattern or the like has been formed on a film surface of a copy or print sheet, said copy or print sheet being formed by affixing a sheet to a film such as a cellophane or a cellophane substitutable material to be swelled in order that a copying or printing operation can be carried out by employing a resin toner; said swelled film surface of the first transfer sheet is affixed to either an adhesive surface of a transparent or semi-transparent adhesive film or an adhesive surface of an adhesive sheet; or the film surface of said first transfer sheet is affixed to either the adhesive surface of the transparent or semi-transparent adhesive film or the adhesive sheet and then is swelled; and said first transfer sheet is removed so as to form the transfer sheet having the transferred pattern on the adhesive surface.

9. (canceled)

10. (canceled)
